(19) United States
(12) Patent Application Publication
(10) Pub. No.: US 2015/0029214 A1
(43) Pub. Date: Jan. 29, 2015

(54) DISPLAY DEVICE, CONTROL METHOD, PROGRAM AND STORAGE MEDIUM

(71) Applicant: PIONEER CORPORATION, KANAGAWA (JP)

(72) Inventor: Shunichi Kumagai, Saitama (JP)

(21) Appl. No.: 14/374,232

(22) PCT Filed: Jan. 26, 2012
(86) PCT No.: PCT/JP2012/051679

§ 371 Date: Jul. 24, 2014

(30) Foreign Application Priority Data
Jan. 19, 2012 (GB) 1200970.0

(51) Int. Cl. G06T 11/60; G09G 5/36; G09G 5/37

(52) U.S. Cl. CPC G06T 11/60; G09G 5/37; G09G 5/363; G06T 2200/32; G06T 2210/22; G09G 2320/10; G09G 2340/0492; G09G 2340/12; G09G 2340/14; G09G 2380/10
USPC 345/625

(57) ABSTRACT

A display device superimposes and displays guide information on an actual image captured by a camera. The display device includes a specifying unit and a display control unit. The specifying unit specifies an overlapping part between guide information and a building in the actual image based on an image-capturing position, position information of the building existing in an image-capturing range of the camera, building shape information of the building, and position information of a facility or a road corresponding to the guide information. The display control unit superimposes and displays the guide information except for a cut-off part on the actual image. The cut-off part herein indicates the overlapping part where the building is to be displayed on a front side of the guide information.

### TECHNICAL FIELD

The present invention relates to a technology for displaying information.

### BACKGROUND TECHNIQUE

Conventionally, there is known a navigation device guiding the driver by using an actual image captured by a camera provided on a vehicle and directed toward the travelling direction. For example, Patent Reference-1 discloses a technique for superimposing a navigation information (guide information) on an image illustrating the scenery in front of the vehicle.

Patent Reference-1: Japanese Patent Application Laid-open under No. 2008-020288

### DISCLOSURE OF INVENTION

### Problem to be Solved by the Invention

In case of superimposing a CG (Computer Graphics) image indicating guide information such as a guide route on an actual image, display corresponding to an invisible road shielded by a building is superimposed on the actual image. Unfortunately, in this case, the depth feeling is lost due to the superposition of the CG image on the actual image and it becomes difficult for the user to intuitively perceive the distance between the building and the road corresponding to the CG image.

The above is an example of the problem to be solved by the present invention. An object of the present invention is to provide a display device, a control method and a program thereof capable of properly keeping the depth feeling even in a case that navigation information is superimposed on an actual image.

### Means for Solving the Problem

One invention is a display device superimposing and displaying guide information on an actual image captured by a camera, including: a specifying unit configured to specify an overlapping part between guide information and a building in the actual image based on an image-capturing position, position information of the building existing in an image-capturing range of the camera, building shape information of the building, and position information of a facility or a road corresponding to the guide information; and a display control unit configured to superimpose and display the guide information except for a cut-off part on the actual image, the cut-off part indicating the overlapping part where the building is to be displayed on a front side of the guide information.

Another invention is a display device superimposing and displaying guide information on an actual image captured by a camera, the actual image including a first building image and a second building image, the second building image indicating a building existing farther from the camera than a building indicated by the first building image, the display device including a display control unit configured to display the guide information in the actual image so that the guide information is closer to the camera than the second building image and display the first building image in a state that the first building image is closer to the camera than the guide information and shields a part of the guide information, the guide information indicating a route existing between the building indicated by the first building image and the building indicated by the second building image.

Still another invention is a control method executed by a display device superimposing and displaying guide information on an actual image captured by a camera, the method including: a specifying process for specifying an overlapping part between guide information and a building in the actual image based on an image-capturing position, position information and building shape information of a building existing in an image-capturing range of the camera, and position information of a facility or a road corresponding to the guide information; and a display control process for superimposing and displaying the guide information except for a cut-off part on the actual image, the cut-off part indicating the overlapping part where the building is to be displayed on a front side of the guide information.

Still another invention is a control method executed by a display device superimposing and displaying guide information on an actual image captured by a camera, the actual image including a first building image and a second building image, the second building image indicating a building existing farther from the camera than a building indicated by the first building image, the method including a display control process for displaying the guide information in the actual image so that the guide information is closer to the camera than the second building image and displaying the first building image in a state that the first building image is closer to the camera than the guide information and shields a part of the guide information, the guide information indicating a route existing between the building indicated by the first building image and the building indicated by the second building image.

Still another invention is a program executed by a display device superimposing and displaying guide information on an actual image captured by a camera, the program making the display device function as: a specifying unit configured to specify an overlapping part between guide information and a building in the actual image based on an image-capturing position, position information of the building existing in an image-capturing range of the camera, building shape information of the building, and position information of a facility or a road corresponding to the guide information; and a display control unit configured to superimpose and display the guide information except for a cut-off part on the actual image, the cut-off part indicating the overlapping part where the building is to be displayed on a front side of the guide information.

### BRIEF DESCRIPTION OF THE DRAWINGS

FIG. 1 illustrates the schematic configuration of a navigation device.

FIG. 2 illustrates a flowchart indicating the procedure of a process according to an embodiment.

FIG. 3A is an example of an actual image captured by a camera.

FIG. 3B is an example of an actual image on which a guide route image is superimposed.

FIG. 4 is a display example according to a comparison example.

FIG. 5 is a display example according to a modification.

### DETAILED DESCRIPTION OF THE PREFERRED EMBODIMENTS

According to a preferable embodiment of the present invention, there is provided a display device superimposing and displaying guide information on an actual image captured by a camera, including: a specifying unit configured to specify an overlapping part between guide information and a building in the actual image based on an image-capturing position, position information of the building existing in an image-capturing range of the camera, building shape information of the building, and position information of a facility or a road corresponding to the guide information; and a display control unit configured to superimpose and display the guide information except for a cut-off part on the actual image, the cut-off part indicating the overlapping part where the building is to be displayed on a front side of the guide information.

The display device is a navigation device, for example, and superimposes and displays guide information on an actual image captured by a camera. The display device includes a specifying unit and a display control unit. The specifying unit specifies an overlapping part between guide information and a building in the actual image based on an image-capturing position, position information of the building existing in an image-capturing range of the camera, building shape information of the building, and position information of a facility or a road corresponding to the guide information. The display control unit superimposes and displays the guide information except for a cut-off part on the actual image. The cut-off part herein indicates the overlapping part where the building is to be displayed on a front side of the guide information.

Generally, superimposing, on the actual image, guide information corresponding to an invisible road or a facility shielded by a building causes a loss of depth feeling. In consideration of the fact, the above-mentioned display device superimposes, on the actual image, the guide information except for the cut-off part where the building is to be displayed nearer than the guide information. Thereby, the display device can keep the depth feeling even when superimposing the navigation information on the actual image.

In one mode of the display device, the specifying unit specifies the overlapping part by rendering the building in a substantially-transparent state based on the position information and the building shape information of the building and rendering the guide information based on the position information of the facility or the road, and the display control unit generates a composite image of the building in the substantially-transparent state and the guide information in which the cut-off part is eliminated, and superimposes the composite image on the actual image. According to this mode, the display device can properly specify the overlapping part between the actual image and the guide information. By rendering the building in a substantially-transparent state, the display device can prevent the display of the building drawn for preventing the cut-off part of the guide information from remaining in the actual image even when superimposing the composite image on the actual image.

In another mode of the display device, the display control unit generates the composite image by rendering the building in the substantially-transparent state prior to the guide information and thereafter blending color of the building in the substantially-transparent state with color of the guide information with respect to the overlapping part except for the cut-off part. In this mode, the display device can properly generate the composite image from which the cut-off part of the guide information is eliminated.

In still another mode of the display device, the display control unit superimposes and displays a route where a moving body is going to run on the actual image as the guide information. In this mode, the display device can properly omit the display of a part shielded by the building from the guide route to be displayed and keep the depth feeling even when superimposing the guide information on the actual image.

In still another mode of the display device, the display control unit displays the route upside-down at a position in a sky above a road corresponding to the route. Even in this mode, the display device can omit the display of the part of the guide route to be displayed which is shielded by the building thereby to keep the depth feeling even when superimposing the guide information on the actual image.

In still another mode of the display device, the display control unit superimposes and displays, on the actual image, a mark indicating a facility as the guide information at a position corresponding to the facility in the actual image. In this mode, the display device can properly omit the display of the part shielded by a building that exists nearer than the facility even when displaying the mark of the facility.

In still another mode of the display device, the display control unit displays the mark except for the cut-off part only if the mark corresponds to the facility in the actual image serving as a landmark of route guide. Thereby, the user can precisely recognize the position of the facility serving as a landmark for driving without misidentifying it.

According to another preferable embodiment of the present invention, there is provided a display device superimposing and displaying guide information on an actual image captured by a camera, the actual image including a first building image and a second building image, the second building image indicating a building existing farther from the camera than a building indicated by the first building image, the display device including a display control unit configured to display the guide information in the actual image so that the guide information is closer to the camera than the second building image and display the first building image in a state that the first building image is closer to the camera than the guide information and shields a part of the guide information, the guide information indicating a route existing between the building indicated by the first building image and the building indicated by the second building image. Even in this mode, the display device can also keep the depth feeling properly when superimposing the guide information on the actual image.

In one mode of the display device, the display control unit superimposes and displays the first building image on the guide information. According to this mode, the display device can properly display the first building image nearer than the guide information thereby to keep the depth feeling.

According to still another preferable embodiment of the present invention, there is provided a control method executed by a display device superimposing and displaying guide information on an actual image captured by a camera, the method including: a specifying process for specifying an overlapping part between guide information and a building in the actual image based on an image-capturing position, position information of the building existing in an image-capturing range of the camera, building shape information of the building, and position information of a facility or a road corresponding to the guide information; and a display control process for superimposing and displaying the guide information except for a cut-off part on the actual image, the cut-off part indicating the overlapping part where the building is to be displayed on a front side of the guide information. By using the control method, the display device can keep the proper depth feeling even when superimposing the guide information on the actual image.

According to still another preferable embodiment of the present invention, there is provided a control method executed by a display device superimposing and displaying guide information on an actual image captured by a camera, the actual image including a first building image and a second building image, the second building image indicating a building existing farther from the camera than a building indicated by the first building image, the method including a display control process for displaying the guide information in the actual image so that the guide information is closer to the camera than the second building image and displaying the first building image in a state that the first building image is closer to the camera than the guide information and shields a part of the guide information, the guide information indicating a route existing between the building indicated by the first building image and the building indicated by the second building image. By using the above control method, the display device can also keep the proper depth feeling when superimposing the guide information on the actual image.

According to still another preferable embodiment of the present invention, there is provided a program executed by a display device superimposing and displaying guide information on an actual image captured by a camera, the program making the display device function as: a specifying unit configured to specify an overlapping part between guide information and a building in the actual image based on an image-capturing position, position information of the building existing in an image-capturing range of the camera, building shape information of the building, and position information of a facility or a road corresponding to the guide information; and a display control unit configured to superimpose and display the guide information except for a cut-off part on the actual image, the cut-off part indicating the overlapping part where the building is to be displayed on a front side of the guide information. By executing the program, the display device can keep the depth feeling properly even when superimposing the guide information on the actual image. Ina preferred example, the above program is stored in a recording medium.

### Embodiment

Now, a preferred embodiment of the present invention will be described below with reference to the attached drawings.

[Configuration of Navigation Device]

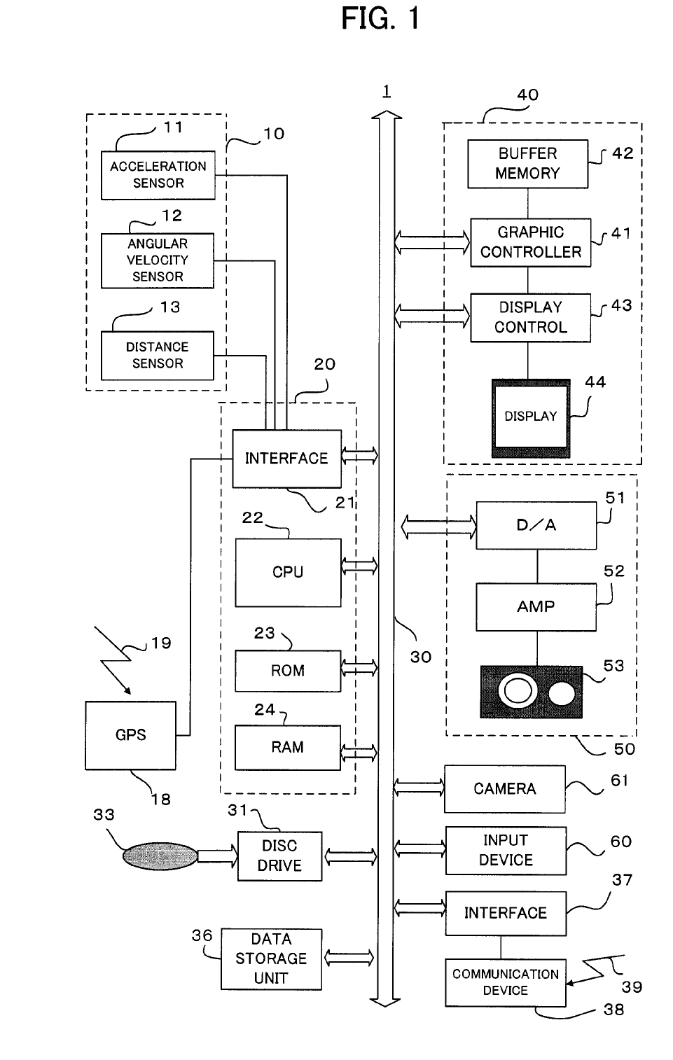

FIG. 1 shows a device configuration of the navigation device 1. As shown in FIG. 1, the navigation device 1 includes a stand-alone position measurement device 10, a GPS receiver 18, a system controller 20, a disc drive 31, a data storage unit 36, a communication interface 37, a communication device 38, a display unit 40, a sound output unit 50, an input device 60 and a camera 61. In accordance with a destination which has already been set, the navigation device 1 superimposes a guide route for arriving at the destination on an actual image captured by the camera 61.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated in response to the wheel rotation of the vehicle.

The GPS receiver 18 receives an electric wave 19 for transmitting downlink data including position measurement data from plural GPS satellites, which is used for detecting the absolute position (hereinafter referred to as “present position”) of the vehicle from longitude and latitude information.

The system controller 20 includes an interface 21, a CPU (Center Processing Unit) 22, a ROM (Read Only Memory) 23 and a RAM (Random Access Memory) 24, and is configured to control the entire navigation device 1.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes a HDD, for example, and stores various kinds of data used for a navigation process such as map data. Road data and facility information are included in the map data. With respect to a facility that is a building, the facility information also includes information (i.e., building shape information) on the shape of the building in addition to the name and the position information of the facility. For example, the building shape information includes information on the range of the location of the building and the height of the building. The building shape information is used for illustrating a street map by a CG image and also used for depth determination between the guide route and a building in the image as mentioned later.

The communication device 38 includes an FM tuner or a beacon receiver, a mobile phone and a dedicated communication card for example, and obtains information (hereinafter referred to as “VICS information”) delivered from a VICS (Vehicle Information Communication System; Registered Trademark) center by the electric wave 39. The communication interface 37 executes the interface operation of the communication device 38 to input the VICS information into the system controller 20.

The display unit 40 displays various kinds of display data on a display screen of a display 44 under the control of the system controller 20. Concretely, the system controller 20 reads the map data from the data storage unit 36, and the display unit 40 displays, on its display screen, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A (Digital to Analog) conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 44 is in a touch panel system, a touch panel provided on the display screen of the display 44 also functions as the input device 60.

The camera 61 is an optical device that has a predetermined angle of view and that shoots an object existing in the angle of view. In the embodiment, the camera 61 is directed to the front of the vehicle and mounted on such a position that the camera 61 can shoot the running road of the vehicle. Then, the camera 61 generates an image (referred to as “actual image”) in a predetermined cycle to supply it to the system controller 20.

[Display Method of Guide Route]

Next, a description will be given of the display method of the guide route executed by the system controller 20. In summary, the system controller 20 superimposes, on the actual image, a guide route image except for a part (referred to as “cut-off part”) where the driver cannot see due to the existence of a building existing nearer than the route. Thereby, even when superimposing the guide route on the actual image, the system controller 20 keeps the depth feeling while letting the driver perceive a sense of distance.

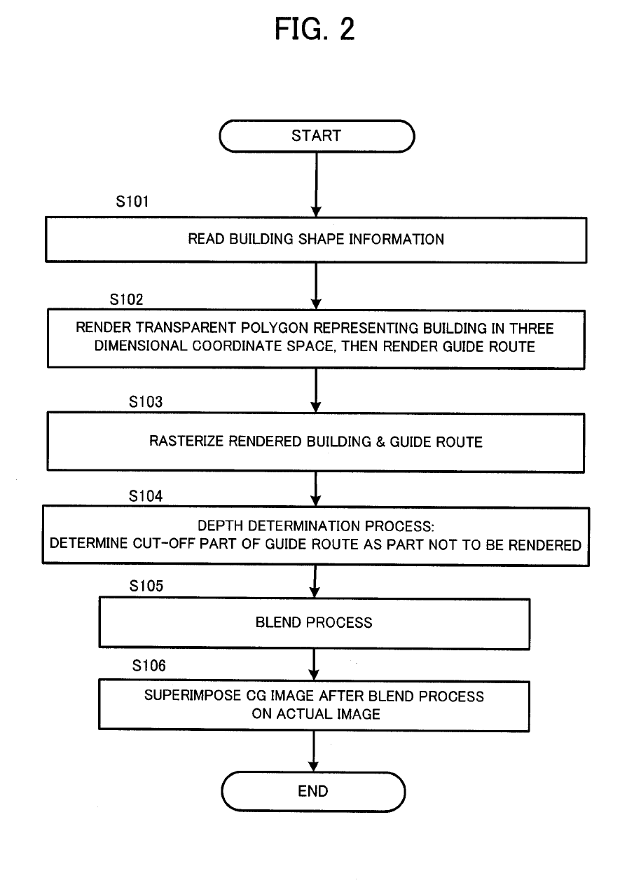

This process will be concretely explained with reference to FIG. 2. FIG. 2 is an example of a flowchart indicating a procedure of the process according to the embodiment. The system controller 20 executes the process indicated by the flowchart in FIG. 2 every time it receives the actual image from the camera 61, for example. It is noted that the procedure of the process conforms to general computer graphic software such as OpenGL (registered trademark) and DirectX (registered trademark) and can be preferably executed by the above-mentioned software. Hereinafter, the term “blend process” indicates a process for blending the color of a pixel to be rendered with a pixel which has already been rendered.

First, the system controller 20 reads the building shape information and the like from the data storage unit 36 (step S101). Concretely, the system controller 20 firstly specifies the image-capturing range of the camera 61 based on the present position recognized by using the GPS receiver 18. In this case, for example, the system controller 20 specifies a predetermined range from the present position toward the traveling direction of the vehicle as the image-capturing range. For example, the above-mentioned predetermined range is determined in advance in consideration of the installation position, the installation direction and the angle of view of the camera 61. Next, by referring to the map data, the system controller 20 specifies each building existing in the image-capturing range, and reads the building shape information and the position information of each specified building from the map data.

Next, the system controller 20 renders transparent polygons each representing a building in the three dimensional coordinate space, and renders the guide route thereafter (step S102). Concretely, the system controller 20 firstly generates the three dimensional coordinate space corresponding to an image-capturing range where the present position of the vehicle is set as the point of view, and arranges the polygon generated by the building shape information in the three dimensional coordinate space. Thereafter, the system controller 20 renders the guide route at a position overlapping with the road corresponding to the guide route. In other words, the system controller 20 renders the guide route at such a position that has the same depth as the road corresponding to the guide route, i.e., such a position that the judgment on whether the position is nearer or farther than any building is the same as the judgment on whether the road is nearer or farther than the building.

Next, the system controller 20 rasterizes the building and the guide route rendered in the three dimensional coordinate space, i.e., changes them into position information and color information per pixel (step S103). Concretely, the system controller 20 generates a raster image in which the three dimensional coordinate space including the rendered polygon of the building and the guide route is projected onto the image-capturing direction from the position of the camera 61. In this case, regarding the overlapping part between the polygon of the building and the guide route, the system controller 20 firstly renders the display of the building, and thereafter determines whether or not to further render the display of the guide route in accordance with the depth determination process at step S104 to be mentioned later. Then, when determining that the guide route should be rendered in accordance with the result of the depth determination process, the system controller 20 performs the blend process at step S105.

Next, the system controller 20 performs the depth determination process, i.e., a depth test, for distinguish between a part of the guide route to be rendered and the other part of the guide route not to be rendered (step S104). Concretely, with respect to each rasterized pixel, the system controller 20 determines whether or not there is an overlap between the display of the building and the display of the guide route. Then, the system controller 20 determines a target pixel of the process where there is no overlap between the display of the building and the display of the guide route as a part of the guide route to be rendered.

In contrast, when determining that the display of the building overlaps with the display of the guide route in the target pixel of the process, the system controller 20 additionally determines whether or not the display of the building is on the back side of the display of the guide route. When the display of the building is on the back side of the display of the guide route, the system controller 20 determines the display of the guide route in the target pixel of the process as a part to be rendered. In contrast, when the display of the building is on the front side of the display of the guide route, the system controller 20 determines the display of the guide route in the target pixel of the process as a part not to be rendered. As a result, the cut-off part of the guide route shielded by the building is determined as a part not to be rendered.

In this way, by performing the depth determination process prior to the blend process at step S105 to be mentioned later, the system controller 20 can properly eliminate the part of the guide route existing on the back side of the polygon of the building from the part to be rendered even though the polygon of the building is transparently rendered.

Next, the system controller 20 performs the blend process (step S105). Concretely, the system controller 20 performs the blend process for blending the part of the guide route determined to be rendered according to the result of the depth determination process with the image in which the transparent building has already been rendered. Since the display color of the building has been set to the transparent color, the system controller 20 generates an image in which only the part of the guide route determined to be rendered is displayed as a result.

Then, the system controller 20 superimposes the CG image (composite image) obtained through the blend process on the actual image and displays them on the display 44 (step S106). In other words, the system controller 20 displays on the display 44 the CG image whose background image is the actual image. Thereby, the system controller 20 can properly hide the part of the guide route shielded by the building and keep the depth feeling while letting the driver perceive a sense of distance even when superimposing the CG image on the actual image.

### Display Example

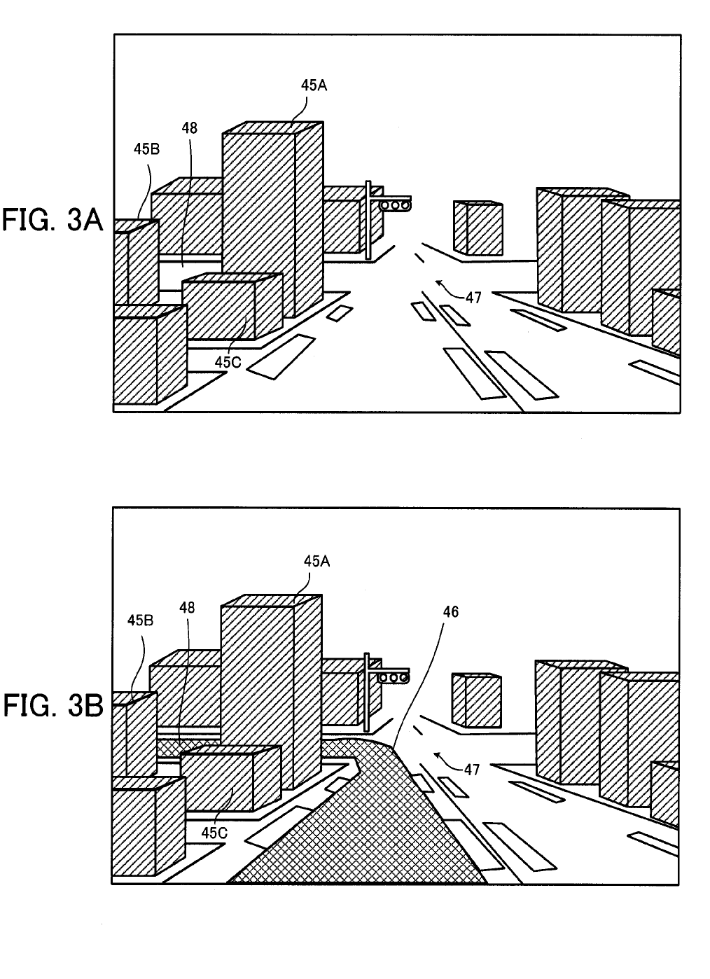

Next, with reference to FIGS. 3A and 3B, a concrete description will be given of the display mode of the guide route according to the embodiment. FIG. 3A illustrates an actual image captured by the camera 61 at the time when the vehicle is running. FIG. 3B illustrates an actual image in which the guide route 46 that is a CG image is superimposed on the actual image.

In this case, as illustrated in FIG. 3B, the system controller 20 displays on the display 44 the guide route 46 indicating turning left at the intersection 47. Concretely, the system controller 20 illustrates the guide route 46 by drawing the curved line with a width corresponding to the road width at a position overlapping with the road where the vehicle is going to run. At that time, on the basis of the building shape information and the position information of the buildings 45A to 45C and the position information of the road 48, the system controller 20 superimposes, on the actual image, the guide route 46 whose cut-off part created due to the existence of the polygons of the buildings 45A to 45C is eliminated in accordance with the process indicated by FIG. 2.

In this case, the road 48 on the guide route where the vehicle is going to run after passing the intersection 47 is on the back side of the buildings 45A to 45C from the viewpoint of the camera 61. Thus, in the actual image illustrated in FIG. 3A, a part of the road 48 is shielded and hidden by the buildings 45A to 45C. Accordingly, regarding the guide route 46 illustrated in FIG. 3B, a part thereof overlapping with the buildings 45A to 45C is hidden in the same way as the road 48 in the actual image. Thereby, the user can easily recognize the necessity to run on the road existing behind the building 45A after turning left and precisely perceive the positional relationship between the nearby buildings and the road where the user needs to run after turning left or right.

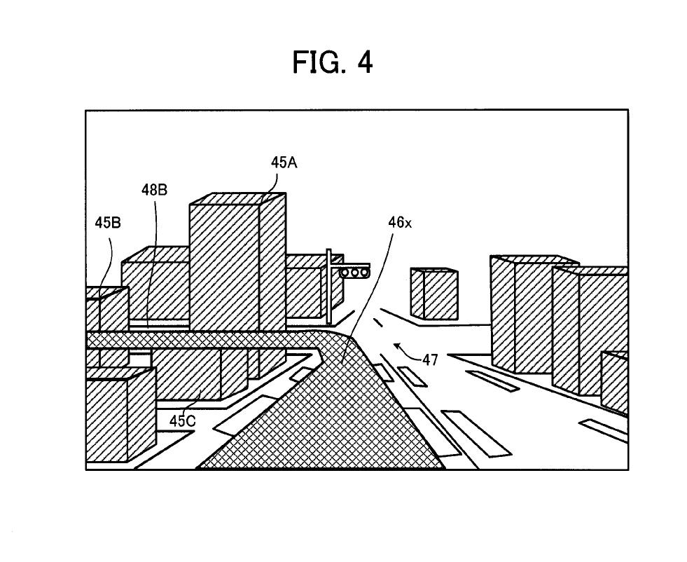

FIG. 4 illustrates an image according to a comparison example in which the CG image of the guide route is superimposed on the actual image regardless of the positional relationship between the buildings and the guide route. As illustrated in

FIG. 4 according to the comparison example, apart of the buildings 45A to 45C is hidden by the guide route 46x. As a result, the user cannot intuitively perceive whether the road 48B after turning left exists on the front side or on the back side of the building 45A. In this way, according to the comparison example illustrated in FIG. 4, superimposing the CG image on the actual image spoils the depth feeling.

In consideration of the above facts, according to the embodiment, the system controller 20 performs the depth determination process between the polygon virtually representing each building and the display of the guide route, and does not display a cut-off part of the guide route shielded by the polygon of the building. Thereby, the system controller 20 properly prevents losing the depth feeling even when superimposing the CG image on the actual image.

[Modification]

Hereinafter, preferred modifications of the above-mentioned embodiment will be described below. Each modification mentioned below can be applied to the above-mentioned embodiment in combination.

(First Modification)

The display mode of the guide route to which the present invention can be applied is not limited to such a display mode, as illustrated in FIG. 3B, that the guide route is superimposed on the road where the vehicle is going to run. Instead of this, the system controller 20 may display the guide route at a different position from the road corresponding to the guide route without superimposing the guide route on the road.

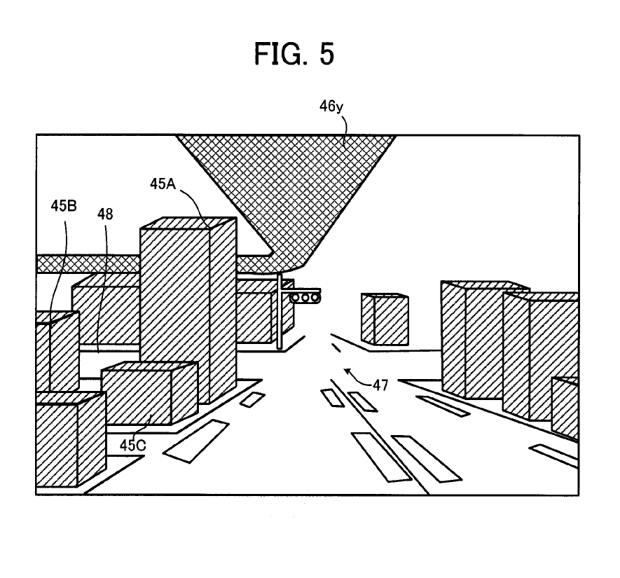

FIG. 5 illustrates a display example of the guide route according to the modification. As illustrated in FIG. 5, the system controller 20 displays the guide route 46y upside-down at a position of the sky above the road where the vehicle is going to run. In this case, when rendering the guide route 46y in the three dimensional coordinate space at step S102 in FIG. 2, the system controller 20 displays the guide route 46y above the road corresponding to the guide route 46y by a predetermined distance and with the same depth as the road. As a result, as illustrated in FIG. 5, the system controller 20 displays the guide route 46y so that a part of the guide route overlapping with the building 45A existing on the front side of the road 48 is hidden.

Thus, even according to the display mode illustrated in FIG. 5, the user can easily recognize the necessity to run on the road existing behind the building 45A after turning left and precisely perceive the positional relationship between the nearby buildings and the road where the user needs to run after turning left or right.

(Second Modification)

The object whose cut-off part shielded by a building is omitted is not limited to the guide route. Instead of this, or in addition to this, in the same way, the navigation device 1 may omit the cut-off part of any guide information shielded by a building other than the guide route. The term “guide information” herein indicates information for letting the driver virtually recognize in order to assist the driving operation such as a mark (referred to as “facility mark”) indicating a facility and displayed at a position corresponding to the facility, information on a facility (e.g., a tower) serving as a landmark, and traffic jam lines displayed along clogged roads.

For example, when displaying a facility mark corresponding to a facility existing in the image-capturing range of the camera 61, the system controller 20 executes the process at step S101 to step S106 in FIG. 2 regarding the facility mark. At that time, at step S102, the system controller 20 firstly arranges the polygons of buildings in the three dimensional coordinate space, and thereafter arranges each facility mark at a display position with the same depth as the corresponding facility. Thereby, the system controller 20 prevents displaying the facility mark in a state that it overlaps with the building existing on the front side of the facility corresponding to the facility mark, and can surely suppress the user from misidentifying the correspondence between the facility and the facility mark.

Preferably, the system controller 20 may perform the non-display process of the cut-off part in the same way as the embodiment only when displaying the facility mark serving as a landmark at the time of driving along with the guide route. Thereby, the system controller 20 can let the driver properly recognize the position of the facility serving as a landmark of driving operation. In this case, the system controller 20 may display other kind of facility mark without considering whether or not it has a cut-off part. Thereby, the system controller 20 can let the user easily discover the target facility when the user searches for a facility to drop by.

(Third Modification)

The procedure of the process indicated by the flowchart in FIG. 2 is an example and the procedure of the process to which the present invention can be applied is not limited to this. For example, on the basis of the building shape information and the position information of each building and the position information of the road corresponding to the guide route, the navigation device 1 may specify the part of the guide route overlapping with a building without generating any transparent polygons of buildings. Thereafter, the navigation device 1 superimposes an image of the guide route whose cut-off part is hidden on the actual image. In another example, the system controller 20 may change the execution sequence regarding a part of the process if necessary according to the specification of software to be used.

(Fourth Modification)

When rendering a polygon representing a building at step S102 in FIG. 2, the system controller 20 may render a substantially-transparent polygon instead of a completely-transparent polygon. For example, the system controller 20 may render a polygon with such a transmittance that the polygon of the building does not stand out at the time when the CG image is superimposed on the actual image. Even in this case, in the same way as the embodiment, it is possible to output a display screen giving the driver the proper depth feeling by hiding the cut-off part of the guide route shielded by the building.

(Fifth Modification)

At step S102 in FIG. 2, the system controller 20 renders polygons corresponding to all buildings existing in the image-capturing range of the camera 61. Instead of this, the system controller 20 may render some of polygons of buildings existing in the image-capturing range. Concretely, the system controller 20 may generate polygons only corresponding to buildings existing on the front side of the road corresponding to the guide route in the travelling direction. Even in this case, the system controller 20 can output a display screen giving the driver the proper depth feeling by hiding the cut-off part of the guide route shielded by the building.

### INDUSTRIAL APPLICABILITY

Preferably, this invention can be applied to a device capable of outputting guide display based on an actual image captured by a camera.

### BRIEF DESCRIPTION OF REFERENCE NUMBERS

1 Navigation device
10 Stand-alone position measurement device
12 GPS receiver
20 System controller
22 CPU
36 Data storage unit
38 Communication device
40 Display unit
44 Display

1. A display device superimposing and displaying guide information on an actual image captured by a camera, comprising:
a specifying unit configured to specify an overlapping part between guide information and a building in the actual image based on an image-capturing position, position information of the building existing in an image-capturing range of the camera, building shape information of the building, and position information of a facility or a road corresponding to the guide information; and
a display control unit configured to superimpose and display the guide information except for a cut-off part on the actual image, the cut-off part indicating the overlapping part where the building is to be displayed on a front side of the guide information,
wherein the display control unit superimposes and displays, on the actual image, a mark indicating a facility as the guide information at a position corresponding to the facility in the actual image, and
wherein the display control unit omits the cut-off part at least regarding the mark corresponding to the facility in the actual image serving as a landmark of route guide.

2. The display device according to claim 1,
wherein the specifying unit specifies the overlapping part by rendering the building in a substantially-transparent state based on the position information and the building shape information of the building and rendering the guide information based on the position information of the facility or the road, and
wherein the display control unit generates a composite image of the building in the substantially-transparent state and the guide information from which the cut-off part is eliminated, and superimposes the composite image on the actual image.

3. The display device according to claim 2,
wherein the display control unit generates the composite image by rendering the building in the substantially-transparent state prior to the guide information and thereafter blending color of the building in the substantially-transparent state with color of the guide information with respect to the overlapping part except for the cut-off part.

4. The display device according to claim 1,
wherein the display control unit superimposes and displays a route where a moving body is going to run on the actual image as the guide information.

5. The display device according to claim 4,
wherein the display control unit displays the route upside-down at a position in a sky above a road corresponding to the route.

6. (canceled)

7. The display device according to claim 1,
wherein the display control unit displays the mark except for the cut-off part only if the mark corresponds to the facility in the actual image serving as a landmark of route guide.

8-9. (canceled)

10. A control method executed by a display device superimposing and displaying guide information on an actual image captured by a camera, the method comprising:
a specifying process for specifying an overlapping part between guide information and a building in the actual image based on an image-capturing position, position information of the building existing in an image-capturing range of the camera, building shape information of the building, and position information of a facility or a road corresponding to the guide information; and
a display control process for superimposing and displaying the guide information except for a cut-off part on the actual image, the cut-off part indicating the overlapping part where the building is to be displayed on a front side of the guide information,
wherein the display control process superimposes and displays, on the actual image, a mark indicating a facility as the guide information at a position corresponding to the facility in the actual image, and
wherein the display control process omits the cut-off part at least regarding the mark corresponding to the facility in the actual image serving as a landmark of route guide.

11. (canceled)

12. A program stored on a non-transitory storage medium and executed by a display device superimposing and displaying guide information on an actual image captured by a camera, the program making the display device function as:
a specifying unit configured to specify an overlapping part between guide information and a building in the actual image based on an image-capturing position, position information of the building existing in an image-capturing range of the camera, building shape information of the building, and position information of a facility or a road corresponding to the guide information; and
a display control unit configured to superimpose and display the guide information except for a cut-off part on the actual image, the cut-off part indicating the overlapping part where the building is to be displayed on a front side of the guide information,
wherein the display control unit superimposes and displays, on the actual image, a mark indicating a facility as the guide information at a position corresponding to the facility in the actual image, and
wherein the display control unit omits the cut-off part at least regarding the mark corresponding to the facility in the actual image serving as a landmark of route guide.

13. (canceled)
